(19) United States
(12) Patent Application Publication
(10) Pub. No.: US 2025/0016263 A1
(43) Pub. Date: Jan. 9, 2025

(54) System and Method for Downloading Content for Display on a Lock Screen

(71) Applicant: GLANCE INMOBI PTE. LIMITED, Singapore (SG)

(72) Inventors: Ian Anderson, Monmouthshire (GB); Paul Duff, London (GB)

(73) Assignee: GLANCE INMOBI PTE. LIMITED, Singapore (SG)

(21) Appl. No.: 18/491,505

(22) Filed: Oct. 20, 2023

(30) Foreign Application Priority Data
Jul. 6, 2023 (IN) 202341045397

(51) Int. Cl. H04M 1/72463; H04W 24/08

(52) U.S. Cl. CPC H04M 1/724634; H04W 24/08

(57) ABSTRACT

Disclosed is a method for downloading a volume of content to a user device (100-2). The method includes steps of a) detecting one or more network connectivity events associated with the user device (100-2), b) determining a consumption of content by a user when content is displayed on a lock screen of the user device (100-2), c) predicting a next time interval during which the user device is unlikely to have the network connectivity, d) predicting a first volume of content likely to be consumed by the user in a predefined time duration, e) determining, based on the first volume of content, a second volume of content likely to be consumed by the user in the predicted next time interval, f) sending a request to a content server (100-4) for downloading the second volume of content before the predicted next time interval.

### FIELD

The present disclosure relates to the field of information processing. More particularly, the present disclosure relates to a system and a method for downloading content for displaying on a lock screen of a user device.

### BACKGROUND

Presently due to the availability of high-speed mobile networks and the affordability of data plans for smartphones have brought a significant transformation in how individuals engage with digital media. The users have the capability to access a wide variety of digital media content, such as streaming video, music, and gaming, from their smartphones and other mobile devices. Nevertheless, this surge in digital media content has presented certain difficulties, such as the need for personalized content suggestions and effective delivery of tailored content. The increasing volume and complexity of usage of digital media content has presented various challenges such as the requirement for personalized content recommendations and effective delivery of the personalized content.

Further, the delivery of the digital media content to the user device has gained significance due to the growing expectation of the users to access their favourite content at any time and any location. However, there are certain challenges associated with the delivery of the digital media content directly to the user's device at any time and any location. For example, delivering the personalized content via a software application (APP) requires continuous network access to load the digital media content. In a situation when the user device is not connected to any network, the digital media content cannot be delivered to the user device. Furthermore, in another situation, the display screen may be greyed out during the loading of the digital media content. Accordingly, a continuous disruption in accessing the media content leads to an unsatisfactory personalized content experience for a user of the user device.

Furthermore, in the currently available smartphones, the user has to unlock the smartphone and then open the respective APP to access the digital media content. Thus, the user has to perform a certain operation to view their favourite digital media content. There is no method available for the user to access the digital media content without performing these minimum operations on the user device.

Based on the above, there lies a need for a new and improved method that overcomes the above-mentioned limitations of the existing methods of content delivery and provides a more reliable and efficient means of content delivery.

### SUMMARY

This summary is provided to introduce a selection of concepts in a simplified format that is further described in the detailed description of the invention. This summary is not intended to identify key or essential inventive concepts of the invention, nor is it intended for determining the scope of the invention.

The present disclosure discloses a method for downloading a volume of content on a user device, for displaying on a lock screen of the user device, for consumption of a content by a user. The method includes detecting, by a network connectivity monitoring module, one or more network connectivity events based on monitoring a network connectivity of the user device. The method further includes generating, by a network connectivity logger, a first timestamp log including one or more timestamps of the detected one or more network connectivity events. Further, the method includes determining, by a content consumption monitoring module, a consumption of the content by the user when the content is displayed on the lock screen of the user device including when the user device does not have network connectivity. Further, the method includes generating, by a content consumption logger, a second timestamp log including one or more timestamps associated with each of the determined consumption of the content by the user. Further, the method includes predicting, by a network connectivity prediction engine configured for using a first Machine Learning (ML—hereinafter) model, a next time interval, within a predefined time duration, during which the user device is unlikely to have the network connectivity, based on the first timestamp log. Further, the method includes predicting, by a content consumption prediction engine configured for using a second ML model, a first volume of content likely to be consumed by the user in the predefined time duration, based on the second timestamp log. Further, the method includes determining, by a decision engine based on the predicted first volume of content, a second volume of content likely to be consumed by the user in the predicted next time interval. Further, the method includes sending, by the decision engine, a request to a content server for downloading the determined second volume of content at a time before the predicted next time interval.

Also disclosed herein is a system for downloading the volume of content on the user device, for display on the lock screen of the user device, for consumption of the content by the user. The system includes the network connectivity monitoring module configured to detect one or more network connectivity events based on monitoring of the network connectivity of the user device. The system further includes the network connectivity logger configured to generate the first timestamp log including one or more timestamps of the detected one or more network connectivity events. Further, the system includes the content consumption monitoring module configured to determine the consumption of the content by the user when the content is displayed on the lock screen of the user device including when the user device does not have network connectivity. Further, the system includes the content consumption logger configured to generate the second timestamp log including one or more timestamps associated with each of the determined consumption of the content by the user. Further, the system includes the network connectivity prediction engine configured to predict, using the first Machine Learning model, the next time interval, within the predefined time duration, during which the user device is unlikely to have the network connectivity, based on the first timestamp log. Further, the system includes the content consumption prediction engine configured to predict, using the second ML model, the first volume of content likely to be consumed by the user in the predefined time duration, based on the second timestamp log. Further, the system includes the decision engine configured to determine, based on the predicted first volume of content, the second volume of content likely to be consumed by the user in the predicted next time interval. The decision engine is further configured to send the request to the content server for downloading the determined second volume of content at the time before the predicted next time interval.

The proposed method advantageously downloads content in advance, taking into account the user device's network connectivity in the past. This approach ensures a seamless experience for the user, even when they are predicted to be offline in the future. By downloading the content, the user can access and interact with the content without any interruptions or reliance on an internet connection. This method enhances user experience by providing continuous access to the desired content, regardless of network availability.

To further clarify the advantages and features of the method and system, a more particular description of the method and system will be rendered by reference to specific embodiments thereof, which are illustrated in the appended drawing. It is appreciated that these drawings depict only typical embodiments of the invention and are therefore not to be considered limiting its scope. The invention will be described and explained with additional specificity and detail with the accompanying drawings.

### BRIEF DESCRIPTION OF THE DRAWINGS

These and other features, aspects, and advantages will become better understood when the following detailed description is read with reference to the accompanying drawings in which like characters represent like parts throughout the drawings, wherein:

FIG. 1 illustrates a block diagram of a system for downloading a volume of content on a user device, according to one or more embodiments of the present disclosure;

FIG. 2 illustrates a flow chart of a method for downloading the volume of content on the user device, according to one or more embodiments of the present disclosure;

FIG. 3 illustrates a flow chart of a method when a state of battery is considered in the method described with reference to FIG. 2, according to one or more embodiments of the present disclosure;

FIG. 4 illustrates a flow chart of a method for downloading a volume of content on the user device when an input from a context monitoring module is considered, according to one or more embodiments of the present disclosure; and

FIG. 5 illustrates a hardware architecture of the user device, according to one or more embodiments of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the invention. Furthermore, in terms of the construction of the device, one or more components of the device may have been represented in the drawings by conventional symbols, and the drawings may show only those specific details that are pertinent to understanding the embodiments of the invention so as not to obscure the drawings with details that will be readily apparent to those of ordinary skill in the art having the benefit of the description herein.

### DETAILED DESCRIPTION

It should be understood at the outset that although illustrative implementations of embodiments are illustrated below, the system and method may be implemented using any number of techniques. The disclosure should in no way be limited to the illustrative implementations, drawings, and techniques illustrated below, including the exemplary design and implementation illustrated and described herein, but may be modified within the scope of the appended claims along with their full scope of equivalents.

The term “some” and “one or more” as used herein is defined as “one, or more than one, or all.” Accordingly, the terms “one,” “more than one,” but not all” or “all” would all fall under the definition of “some.” The term “some embodiments” or “one or more embodiments” may refer to one embodiment or several embodiments or all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein such as but not limited to “includes,” “comprises,” “has,” “have” and other grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “must comprise” or “needs to include.”

The term “unit” used herein may imply a unit including, for example, one of hardware, software, and firmware or a combination of two or more of them. The “unit” may be interchangeably used with a term such as logic, a logical block, a component, a circuit, and the like. The “unit” may be a minimum system component for performing one or more functions or may be a part thereof.

Unless otherwise defined, all terms, and especially any technical and/or scientific terms, used herein may be taken to have the same meaning as commonly understood by one having ordinary skill in the art.

Embodiments will be described below in detail with reference to the accompanying drawings.

One or more embodiments of the present disclosure describe a system for content delivery on a lock screen of a user device. The system may comprise a lock screen platform that enables the user to experience content available on the internet without searching, downloading any apps, or even unlocking the user device. The lock screen platform presents the digital media content including, for example, personalized Artificial Intelligence (AI) driven content, live entertainment, commerce, and gaming on the lock screen of the user device. In a non-limiting example, the user device may include an electronic device associated with the user or any other user device such as a smartphone, or mobile phone associated with the user. In a non-limiting example, the lock screen platform may include content, game-related content, commerce or business related content, images, text, short videos, and the like. The content may feature a variety of different shows that are completed and a calendar of upcoming events. The game-related content may provide users with access to the latest mobile games. The commerce or business related content may provide users with a theme for shopping and commerce. The images and text may provide users with images accompanied by short text descriptions on their lock screen. The short text descriptions may link to a story that the user can read in further detail. The short videos may provide short videos covering a wide range of concepts such as news, entertainment, travel, cooking, and others.

In one or more embodiments, one or more digital media content that is provided for display on the lock screen of the user device is temporal content. The temporal content exists on the user device for a predefined time duration. After the predefined time, the content expires and is not provided to the user on the lock screen. In one or more embodiments, the one or more content may not have a time limit to display on the lock screen of the user device. The temporal content enables the lock screen platform to present a new content to the users when they access the lock screen of the user device. The lock screen platform may always have some digital media content preloaded in the background when a network connectivity is available. The lock screen platform may download a volume of digital media content for the user so that the user device does not run out of content before they reconnect to the internet upon network failure. That is, the system downloads the content when the user device is connected to the internet to display the content on the lock screen of the user device when the user device is not connected to the internet, that is, when the device is offline. The lock screen platform may provide a personalized approach to downloading the volume of the digital media content for a particular user. The personalized approach may take account of network connectivity that is predicted for the particular user. The personalized approach further takes into account content consumption that is predicted for the particular user throughout the day. The disclosed personalized approach may restrict downloading of an excessive volume of the digital media content on the user device and thereby avoiding an increased data cost, increased battery consumption, and increased local storage. The detailed working of the personalized approach is explained in the forthcoming paragraphs.

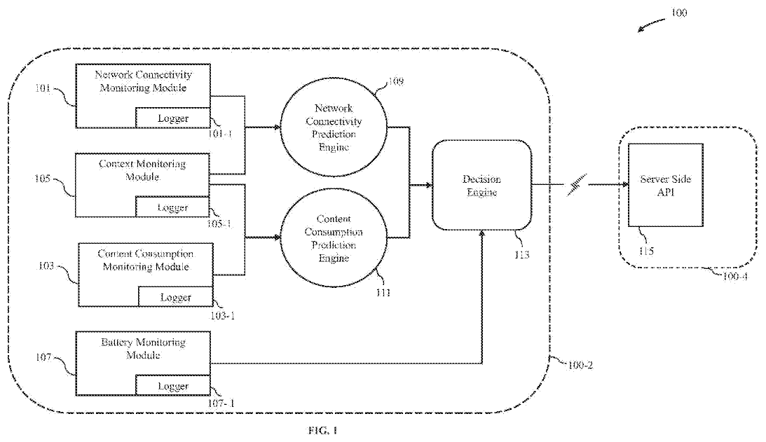

FIG. 1 illustrates a block diagram of the system 100 for downloading a volume of content on a user device 100-2, for display on a lock screen of the user device 100-2, for consumption of a content by a user.

The system 100 may include a network connectivity monitoring module 101, a content consumption monitoring module 103, a context monitoring module 105, a battery monitoring module 107, a network connectivity prediction engine 109, a content consumption prediction engine 111, a decision engine 113, and a server-side Application Programming Interface (API) module 115. The system 100 may further include a network connectivity logger 101-1, a content consumption logger 103-1, a context logger 105-1, and a battery charge level logger 107-1.

The network connectivity monitoring module 101 may monitor a status of network connectivity when the user device 100-2 is connected to the network (online) or not connected (offline) to the network. The network connectivity monitoring module 101 may further monitor a type of network connectivity. According to an embodiment, the type of network connectivity may include 2G, 3G, 4G, 5G, or Wi-Fi connectivity. The network connectivity monitoring module 101 may also monitor a speed of the network connectivity. For example, the Wi-Fi speed of the Wi-Fi connectivity. The network connectivity monitoring module 101 may also monitor changes in the status of the network connectivity and changes in the type of the network connectivity. The network connectivity monitoring module 101 may detect one or more network connectivity events by monitoring the status of the network connectivity and the type of the network connectivity. In a non-limiting example, the network connectivity monitoring module 101 may detect a network connectivity event when the type of the network connectivity of the user device 100-2 changes from cellular to Wi-Fi. In a non-limiting example, the network connectivity monitoring module 101 may detect that the user device 100-2 is currently connected to a Wi-Fi network.

The network connectivity logger 101-1 may keep a log of the output from the network connectivity monitoring module 101. According to an embodiment, the network connectivity logger 101-1 may create logs of the one or more network connectivity events for a predetermined period. In particular, the network connectivity logger 101-1 may generate a first timestamp log including one or more timestamps of the detection of the one or network connectivity events. In a non-limiting example, the predetermined period may be eight days to ensure that the network connectivity logger 101-1 has the history of at least one whole week of network connectivity events including the history of the same day of the week from the previous week. The network connectivity logger 101-1 may store the first timestamp generated log, including one or more timestamps of the detection of the one or network connectivity events, in a memory 569 of the user device 100-2. In a non-limiting example, if the network connectivity monitoring module 101 detects that the user device 100-2 is currently connected to a Wi-Fi network, the network connectivity logger 101-1 may generate a timestamp indicating a time at which the user device 100-2 has an online status and Wi-Fi connection. Thus, the network connectivity logger logs data that includes, but not limited to, times of day at which the network connectivity status of the user device 100-2 changed, the change being between connected to a network or disconnected from the network as well as whether the network to which it connected is a Wi-Fi connection or a mobile data network. Also, the log data includes information that whether the network connectivity has changed within the mobile data network and from which generation of network to which generation of network, namely, 2G, 3G, 4G, or 5G. Further, the network connectivity logger logs each time of changes to a Wi-Fi network and the Wi-Fi network speed.

According to an embodiment, the content consumption monitoring module 103 may determine the consumption of content by a user at a time when the user interacts with the lock screen content. The content consumption monitoring module 103 may determine the consumption of content when the content is displayed on the lock screen of the user device 100-2. The content refers to the digital media content presented to the user on the lock screen by the platform. In particular, determining the consumption of content may include determining a time at which the content is consumed by the user, a duration of content consumption by the user, and a volume of content consumed by the user in the determined duration. Here, the term ‘volume’ refers to the number of individual items of content, for example, a picture, a news item, a video clip, and so on. In a non-limiting example, consuming the content may include looking at the content, reading text in the content, playing the video clip, and other such actions. The content consumption monitoring module 103 may determine how many individual items of content were consumed by the user and how much time the user spent in consuming the content. The content consumption monitoring module 103 may also determine the completion amount of video content, a number of clicks on the content by the user, and a number of repeat views of the same content. In a non-limiting example, the content consumption monitoring module 103 may determine that half of the total length of video content was viewed. Thus, the determination of the half length of the video provides the completion amount of the video. The content consumption monitoring module 103 may also determine a type of the content the user is watching and the time of the consumption of the content. As an example, the type of content the user is watching may include films, games, commercials, songs, shopping websites, and the like. Further, in a non-limiting example, the time of the consumption of the content is related to the time at which the content is being watched by the user. In a non-limiting example, the determining of the consumption of content may be based on monitoring one or more user actions on the lock screen. The one or more actions may include a click operation, a swipe operation, or a scroll operation of the user on the lock screen when the content is displayed on the lock screen. In a non-limiting example, the volume of content consumed by the user may be determined based on a number of swipe operations performed by the user on the lock screen at the time of consuming the content. In a non-limiting example, the content consumption monitoring module 103 may directly interact with the lock screen of the user device 100-2.

The content consumption logger 103-1 may keep a log of the output from the content consumption monitoring module 103. Accordingly, the content consumption logger 103-1 may create logs of the one or more content consumption events. The content consumption logger 103-1 may generate a second timestamp log including one or more timestamps associated with the determined consumption of content by the user. In a non-limiting example, the content consumption logger 103-1 may generate the log whenever the user consumes the content on the lock screen of the user device 100-2. The content consumption logger 103-1 may store the generated second timestamp log, including one or more timestamps associated with the determined consumption of content, in the memory 569 of the user device 100-2.

The battery monitoring module 107 may monitor a battery charge level of the user device 100-2 over the course of the day. The battery monitoring module 107 may also monitor events of charging the battery. The battery monitoring module 107 may monitor the battery charge level of the user device 100-2 and one or more connection events of charging the battery of the user device 100-2.

The battery charge level logger 107-1 may keep a log of the output from the battery monitoring module 107. The battery charge level logger 107-1 may create logs of battery events and battery charge state. In a non-limiting example, the battery charge level logger 107-1 may generate a third timestamp log including one or more timestamps associated with the one or more connection events of charging the battery and the battery charge level over the predetermined time period. In a non-limiting example, the predetermined time period is a period for which the first timestamp log of the one or more network connectivity events is generated. The battery charge level logger 107-1 may store the generated third timestamp log in the memory 569 of the user device 100-2.

The context monitoring module 105 determines context data associated with the user. The context data may include location information of the user at the time of a specific connectivity event of the one or more network connectivity events. The context data may include an activity of the user at the time of the specific connectivity event. In a non-limiting example, the activity may include one of walking, cycling, traveling, and the like.

The context logger 105-1 may keep a log of the output from the context monitoring module 105. The context logger 105-1 may create logs of the context data associated with the user. The context logger 105-1 may generate a fourth timestamp log including one or more timestamps of the one or more context data associated with the user. The context logger 105-1 may store the generated fourth timestamp log, including one or more timestamps of the one or more context data, in the memory 569 of the user device 100-2.

The network connectivity prediction engine 109 generates predictions about a future status of the network connectivity of the user device 100-2. As an example, the future status means an online or offline status of the user device 100-2 in the upcoming time. In particular, the network connectivity prediction engine 109 may use a first Machine Learning model and data from the network connectivity logger 101-1 to generate the predictions. The network connectivity prediction engine 109 may predict, using a first ML model, a future status of the network connectivity for a predefined time duration based on the generated first timestamp log. The predicted future status of the network connectivity may indicate one of an online status or an offline status of the user device 100-2 for the predefined time duration and the type of network connectivity during the predefined time duration. In a non-limiting example, the predefined time duration may be set by the user. In a non-limiting example, the predefined time duration may be determined by the network connectivity prediction engine 109 based on the data from the network connectivity logger 101-1. In one embodiment of the present disclosure, the first ML model is trained using the network connectivity log of the user device 100-2, and the first ML model is used for predicting the probable status of the user device 100-2 in future. For example, the network connectivity prediction engine 109 is configured to predict whether the user device 100-2 will be online or offline between the predefined time duration in the future.

In one embodiment of the present disclosure, the network connectivity prediction engine 109 also uses data from the context logger 105-1 in addition to the data from the network connectivity logger 101-1 to generate the predictions about the future status of the network connectivity. The network connectivity prediction engine 109 uses the data from the network connectivity logger 101-1 as input alongside the data from the context logger 105-1 such as the location information of the user and outputs a prediction as to whether the user will have network connectivity for the predefined time duration. The network connectivity prediction engine 109 predicts, using the first ML model, the future status of the network connectivity for the predefined time duration based on the generated first timestamp log and the generated fourth timestamp log. For example, the network connectivity prediction engine may predict that the user is expected to have the network connectivity for M hours and then for the next N hours, the user may not have any internet connectivity.

The network connectivity prediction engine 109 generates the predictions periodically. In a non-limiting example, the network connectivity prediction engine 109 may generate the predictions in 15 minutes or may generate hourly predictions. In a non-limiting example, the network connectivity prediction engine 109 may generate the prediction that the user may have Wi-Fi connectivity for the next N hours.

The content consumption prediction engine 111 generates predictions about the likelihood of the content consumption in the future. The content consumption prediction engine 111 may use a second machine learning model and data from the content consumption logger 103-1 to generate the predictions. The content consumption prediction engine 111 may predict, using a second ML model, the likelihood of the consumption of content by the user for the predefined time duration based on the generated second timestamp log. The predicted likelihood of the consumption of content by the user for the predefined time duration indicates a volume of content predicted to be consumed by the user in the predefined time duration.

In one embodiment of the present disclosure, the content consumption prediction engine 111 also uses data from the context logger 105-1 in addition to the data from the content consumption logger 103-1 to generate the predictions about the likelihood of the content consumption in the future. The content consumption prediction engine 111 uses the data from content consumption logger 103-1 as an input alongside the data from the context logger 105-1 such as the location information of the user and outputs a predicted number of content the user is expected to consume in the predefined time duration in the future. In a non-limiting example, the content consumption prediction engine 111 predicts, using the second ML model, the likelihood of the consumption of content by the user for the predefined time duration based on the generate second timestamp log and the generated fourth timestamp. Using the context information such as location information may help to identify the anomalies in a general pattern of the user. In a non-limiting example, if the context information identifies that the user is at a new location or not at the usual location, the content consumption prediction engine 111 may generate the predictions that the user may expect to consume greater number of content. For example, if at a particular time, the user is expected to be at home, but the context information indicates that the user is at some other place such as a hotel, the content consumption prediction engine 111 may predict a higher amount of consumption of content.

The content consumption prediction engine 111 may also use a current time and the predefined time period for which the content consumption needs to be predicted as the input along with the data from the content consumption logger 103-1. In a non-limiting example, the content consumption prediction engine 111 may generate the predictions that the user may expect to consume M number of content in the next N hours. The content consumption prediction engine 111 may also determine a confidence level in the prediction about the likelihood of the content consumption in the future. In a non-limiting example, if the user has a very sporadic consumption pattern, the confidence level in the prediction will be lower as compared to users with a regular consumption pattern. In a non-limiting example, if a pattern of consumption of content for the user is not fixed then the likelihood of content consumption may not be correctly predicted for the user.

The decision engine 113 receives inputs from the network connectivity prediction engine 109 and the content consumption prediction engine 111. The received input may include the predicted future status of the network connectivity and the predicted likelihood of the consumption of content by the user. The received input may also include the confidence level in the prediction of the likelihood of the consumption. The decision engine 113 then determines a volume of content to be downloaded and a time of sending a request to the content server 100-4 to download the content based on the received inputs.

In a non-limiting example, if the network connectivity prediction engine 109 predicts that there will be no network connectivity for the next N hours and the content consumption prediction engine 111 predicts that the user may be expected to consume M number of the content in the next N hours, then the decision engine 113 will determine to download at least M number of content for next N hours.

In a non-limiting example, if the network connectivity prediction engine 109 predicts that there will be network availability for the next N hours and the content consumption prediction engine 111 predicts that the user may be expected to consume M pieces of the content in the next N hours, then the decision engine 113 will determine to download less than M number of content for next N hours.

In a non-limiting example, if the network connectivity prediction engine 109 predicts that there will be network availability for the next N hours and the content consumption prediction engine 111 predicts that the user is not expected to consume the content in the next N hours then the decision engine 113 will determine to not send any download request to the content server 100-4.

In a non-limiting example, if the content consumption prediction engine 111 predicts that there is expected to be some additional content consumption during the next N hours, and the network connectivity prediction engine 109 predicts that the network connectivity is currently poor (e.g., 2G) or offline (currently), the decision engine 113 will use the network connectivity prediction for the next few hours to identify whether it expects connectivity to improve. If connectivity is expected to improve, the decision engine 113 waits for the next few hours to download additional content.

The decision engine 113 may also determine a volume of content already present on the user device 100-2. The decision engine 113 may also determine a time when the volume of content already present on the user device 100-2 was downloaded. The decision engine 113 may also discard the content already present on the user device 100-2 after a predefined time duration. In a non-limiting example, the decision engine 113 may download the content in addition to the volume of content already present on the user device 100-2.

In a non-limiting example, the decision engine 113 may download a safe minimum volume of on-device content in addition to the determined volume of content. The safe minimum volume to keep a safety margin of content locally on the user device 100-2 to provide content to the user if any sudden interruption in network connectivity and the user continues to engage with the lock screen platform. In a case when no new content remains, the previously consumed content is presented on the lock screen of the user device 100-2.

The decision engine 113 may also consider the state of the battery. In one or more embodiments, the decision engine 113 may also receive input from the battery charge level logger 107-1. The decision engine 113 then may determine the volume of content to be downloaded and the time of sending the request to the content server 100-4 to download the content based on the data from the battery charge level logger 107-1, the predicted future status of the network connectivity, and the predicted likelihood of the consumption of content by the user.

In a non-limiting example, if the battery charge level logger 107-1 indicates that a battery charge level is below a threshold level then decision engine 113 may download a less volume of content than the determined volume of content. In another non-limiting example, if the battery charge level logger 107-1 indicates that the battery charge level is below the threshold level then decision engine 113 may restrict the transmission of the request to the content server 100-4 to download the content.

In a non-limiting example, if battery charge level logger 107-1 indicates that the user device 100-2 is in a charging state then decision engine 113 may request the content server 100-4 for downloading an additional volume of content in addition to the determined requested volume of content.

In a non-limiting example, when the user finishes an interaction with the lock screen platform, the decision engine 113 makes a new prediction as to when the user is likely to engage next with the lock screen platform and how much content the user is likely to require.

The network connectivity monitoring module 101, the content consumption monitoring module 103, the context monitoring module 105, the battery monitoring module 107, the network connectivity logger 101-1, the content consumption logger 103-1, the context logger 105-1, the battery charge level logger 107-1, the network connectivity prediction engine 109, the content consumption prediction engine 111, and the decision engine 113 may be deployed in the user device 100-2. The server-side API module 115 may be deployed in the content server 100-4.

The server-side API module 115 receives the request from the decision engine 114 that it wants to download the predicted volume of content. After receiving the request, the content server 100-4 delivers the requested volume of the content to the user device 100-2. The content server 100-4 may keep track of the content delivered to the user device 100-2 and may deliver new content each time the server-side API module 115 receives the request. The content server 100-4 may select the new content to be delivered based on the preference of the user of the user device 100-2. The user device 100-2 may store the received content in the memory 569 of the user device 100-2 for displaying on the lock screen of the user device 100-2.

In an alternative embodiment, although not shown in the figures, the network connectivity monitoring module 101, the content consumption monitoring module 103, the context monitoring module 105, the battery monitoring module 107, the network connectivity logger 101-1, the content consumption logger 103-1, the context logger 105-1, and the battery charge level logger 107-1 may be deployed in the user device 100-2. The network connectivity prediction engine 109, the content consumption prediction engine 111, the decision engine 113, and the server-side API module 115 may be deployed in the content server 100-4.

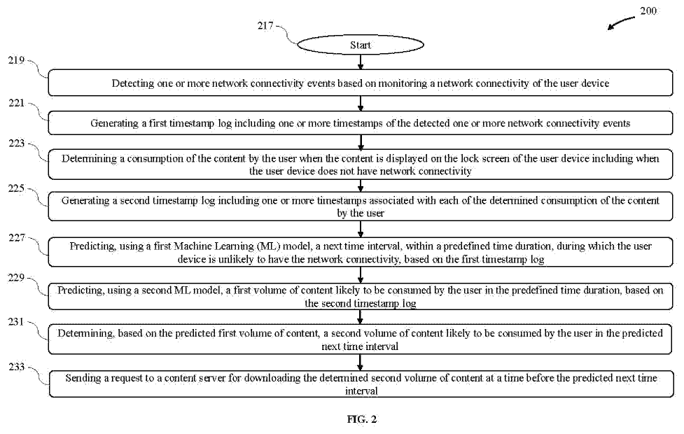

FIG. 2 illustrates a flow chart of the method 200 for downloading a volume of content on the user device 100-2, for displaying on the lock screen of the user device 100-2, for consumption of the content by the user.

At step 217 of the method 200, the user powers on the user device 100-2 which is enabled with the system for content delivery for display in the lock screen of the user device 100-2. At this stage, the user device 100-2 has no data and the user device 100-2 starts collecting the data associated with the one or more network connectivity events, data associated with the consumption of the content, battery information, and context data. The flow of the method 200 now proceeds to step 219.

At step 219, the network connectivity monitoring module 101 monitors the status of the network connectivity of the user device 100-2 and the type of the network to detect one or more network connectivity events. In a non-limiting example, the network connectivity monitoring module 101 may detect that the user device 100-2 is currently connected to the Wi-Fi network. In another non-limiting example, the network connectivity monitoring module 101 may detect that the user device 100-2 is currently connected to the cellular network. In another non-limiting example, the network connectivity monitoring module 101 may detect that the user device 100-2 is currently offline. After detecting the network connectivity, the flow of the method 200 proceeds to step 221.

At the step 221, the network connectivity logger 101-1 may generate a first timestamp log including one or more timestamps of the detected one or network connectivity events. In a non-limiting example, if the network connectivity monitoring module 101 detects that the user device 100-2 is currently connected to the Wi-Fi, the network connectivity logger 101-1 may generate a timestamp indicating a time at which the user device 100-2 has an online status and Wi-Fi connection. In another non-limiting example, if the network connectivity monitoring module 101 detects that the user device 100-2 is currently connected to the cellular network, the network connectivity logger 101-1 may generate a timestamp indicating a time at which the user device 100-2 has an online status and cellular connection. In another non-limiting example, if the network connectivity monitoring module 101 detects that the user device 100-2 is currently offline, the network connectivity logger 101-1 may generate a timestamp indicating that at the current time, the user device 100-2 is offline. The flow of method 200 now proceeds to step 223.

At the step 223, the content consumption monitoring module 103 may determine the consumption of content by the user when the content is displayed on the lock screen of the user device 100-2. The determination of the consumption of content may be based on monitoring one or more user actions on the lock screen. In a non-limiting example, the content consumption monitoring module 103 may determine that the user has consumed M pieces of content in T1 time duration. The flow of the method 200 now proceeds to step 225.

At the step 225, the content consumption logger 103-1 may generate a second timestamp log including one or more timestamps associated with the determined consumption of content by the user. In a non-limiting example, if the content consumption monitoring module 103 determines that the user has consumed the M pieces of content in the T1 time duration, the content consumption logger 103-1 may generate a timestamp indicating that at the T1 time duration, the user consumed the M pieces of content. The content consumption logger 103-1 may also generate a timestamp indicating the start of the T1 time duration and a timestamp indicating the end of the T1 time duration. The flow of the method 200 now proceeds to step 227.

At the step 227, the network connectivity prediction engine 109 may predict, using a first Machine Learning model, a future status of the network connectivity for the predefined time duration based on the generated first timestamp log. The network connectivity prediction engine 109 may predict a next time interval during which the user device 100-2 is unlikely to have the network connectivity. In a non-limiting example, the network connectivity prediction engine 109 may predict that at a first time interval within the next N hours the user device 100-2 will be offline, and at a second time interval within the next N hours the user device 100-2 will be online. The flow of the method 200 now proceeds to step 229.

At the step 229, the content consumption prediction engine 111 may predict, using a second ML model, a likelihood of the consumption of content by the user for the predefined time duration based on the generate second timestamp log. In a non-limiting example, the content consumption prediction engine 111 may predict a volume of content consumed by the user in the next N hours. The content consumption prediction engine 111 may predict that in the first time interval within the next N hours user may consume P pieces of content and in the second time interval within the next N hours user may consume Q pieces of content. The flow of the method 200 now proceeds to step 231.

At the step 231, the decision engine 113 may determine a time for sending a request to a content server 100-4 and a volume of content to be downloaded based on each of the predicted future status of the network connectivity and the predicted likelihood of the consumption of content by the user. In a non-limiting example, if the network connectivity prediction engine predicts that at a first time interval within the next N hours the user device 100-2 will be offline and the content consumption prediction engine predicts that in the first time interval within the next N hours user may consume P pieces of content, the decision engine may determine to download at least P pieces of content. The flow of the method 200 now proceeds to step 233.

At the step 233, the decision engine 113 may send the request to the content server 100-4 for downloading the determined volume of content at the determined time. In a non-limiting example, the decision engine may determine to send the request before the user device 100-2 goes offline.

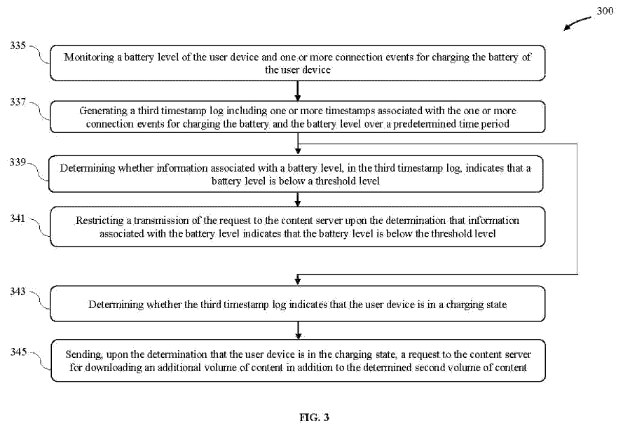

FIG. 3 illustrates a flow chart of method 300 when the state of the battery is considered in the method described with reference to FIG. 2.

At step 335 of the method 300, the battery monitoring module 107 may monitor the battery charge level of the user device 100-2 and one or more connection events for charging the battery of the user device 100-2. In a non-limiting example, the battery monitoring module 107 may detect the battery charge level using a battery charge level sensor. The battery charge level sensor may detect the battery charge level periodically in a predetermined time period. The battery charge level sensor is included in the user device 100-2. The flow of the method 300 now proceeds to step 337.

At the step 337, the battery charge level logger 107-1 may generate a third timestamp log including one or more timestamps associated with the one or more connection events for charging the battery and the battery charge level over a predetermined time period. In a non-limiting example, the third timestamp log may include the battery discharging pattern of the battery. The flow of the method 300 now proceeds to steps 339 or 343.

At the step 339, the decision engine 113 may determine whether information associated with a battery level, in the third timestamp log, indicates that a current battery charge level is below a predefined threshold level. In a non-limiting example, the decision engine 113 may determine the current battery charge level based on one of the information from the battery charge level sensor or the discharging pattern of the battery. The flow of the method 300 now proceeds to step 341.

At the step 341, the decision engine 113 may restrict the transmission of the request, for downloading the determined volume of content at the determined time, to the content server 100-4 upon the determination that information associated with the battery charge level is below the predefined threshold level. In a non-limiting example, the decision engine 113 may download a less volume of content than the determined volume of content in a case when the battery charge level is below the predetermined threshold level.

At the step 343, the decision engine 113 may determine whether a timestamp of the third timestamp log indicates that the user device 100-2 is in a charging state. The flow of the method 300 now proceeds to step 345.

At the step 345, the decision engine 113 may send, upon the determination that the last known timestamp indicates that the user device 100-2 is in the charging state, a request to the content server 100-4 for downloading an additional volume of content in addition to the determined volume of content.

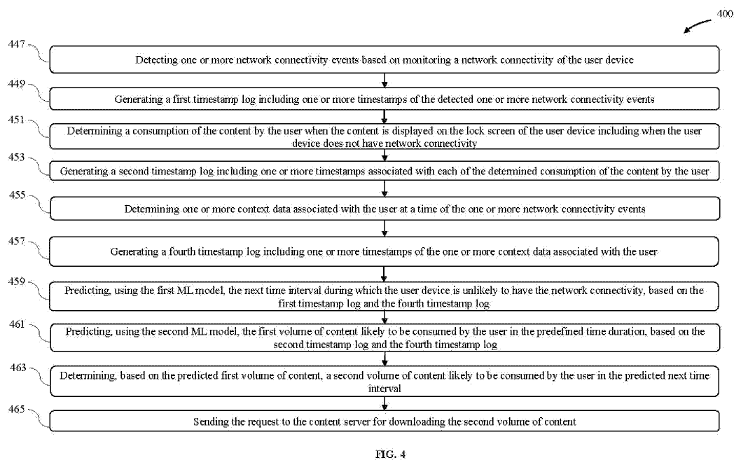

FIG. 4 illustrates a flow chart of the method 400 for downloading a volume of content on the user device 100-2 when an input from the context monitoring module is considered.

The method step from 447 to 453 of the method 400 are the same as the method steps 219 to 225 of the method 200 described with reference to FIG. 2 and therefore a detailed description of the same is omitted herein for the sake of brevity of the disclosure.

At the step 455, the context monitoring module 105 may determine one or more context data associated with the user at a time of the one or more network connectivity events. In a non-limiting example, the context data may include the location information of the user at the time of the one or more network connectivity events. In another non-limiting example, the context data may include an activity of the user at the time of the one or more network connectivity events. In another non-limiting example, the context monitoring module 105 may determine that the user is traveling in a train while consuming the content. In another non-limiting example, the context monitoring module 105 may determine that the user is in a new location rather than the usual location. The flow of the method 400 now proceeds to step 457.

At the step 457, the context logger 105-1 may generate a fourth timestamp log including one or more timestamps of the one or more context data associated with the user. In a non-limiting example, the fourth timestamp log may include a change in the location information of the user. The flow of method 400 now proceeds to step 459.

At the step 459, the network connectivity prediction engine 109 may predict, using the first Machine Learning model, the future status of the network connectivity for the predefined time duration based on the generated first timestamp log and the generated fourth timestamp log. In a non-limiting example, the network connectivity prediction engine 109 may also predict an uncertainty regarding network connectivity if the change in location information of the user indicates that the user is at a completely new location. The flow of the method 400 now proceeds to step 461.

At the step 461, the content consumption prediction engine 111 may predict, using the second ML model, the likelihood of the consumption of content by the user for the predefined time duration based on the generate second timestamp log and the generated fourth timestamp. In a non-limiting example, the content consumption prediction engine 111 may predict a higher volume of content to be consumed if the change in location information of the user indicates that the user is at a completely new location. The flow of the method 400 now proceeds to step 463.

The method steps 463 and 465 of the method 400 are the same as the method steps 231 and 233 of the method 200 of FIG. 2 and therefore a detailed description of the same is omitted herein for the sake of brevity of the disclosure.

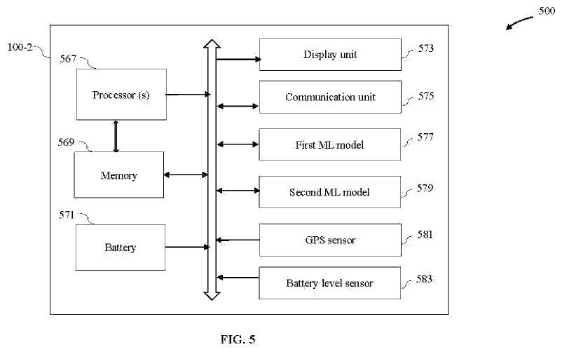

FIG. 5 illustrates a hardware architecture 500 of the user device 100-2. The method disclosed above in FIGS. 1-4 is implemented using the hardware architecture 500.

The user device 100-2 may include a processor 567, the memory 569, a battery 571, a display unit 573, a communication unit 575, the first ML model 577, the second ML model 579, a Global Positioning System (GPS) sensor 581, and a battery charge level sensor 583.

The processor 567 can be a single processing unit or several units, all of which could include multiple computing units. The processor 567 may be implemented as one or more microprocessors, microcomputers, microcontrollers, digital signal processors, central processing units, state machines, logic circuitries, and/or any devices that manipulate signals based on operational instructions. Among other capabilities, the processor 567 is configured to fetch and execute computer-readable instructions and data stored in the memory 569.

The processor 567 may perform one or more functions of one or more components of the system 100 for the personalized content delivery. The processor 567 may also control one or more operations of one or more components of the user device 100-2.

The memory 569 includes one or more computer-readable storage media. The memory 569 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that can, over time, change (e.g., in Random Access Memory (RAM) or cache.

The memory 569 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The battery 571 is configured to provide power to the one or more components of the user device 100-2. The battery 571 is configurable to be charged when connected to a power source.

The display unit 573 is configured to display the content to the user associated with the user device 100-2. The display unit 573 may include a display screen. As a non-limiting example, the display screen may be Light Emitting Diode (LED). Liquid Crystal Display (LCD). Organic Light Emitting Diode (OLED), Active Matrix Organic Light Emitting Diode (AMOLED), or Super Active Matrix Organic Light Emitting Diode (SAMOLED) screen. The display screen may be of varied resolutions.

The communication unit 575 is configured to communicate voice, video, audio, images, or any other digital media content over a communication network. Further, the communication unit 575 may include a communication port or a communication interface for sending and receiving notifications from the user device 100-2 via the communication network. The communication port or the communication interface may be a part of a processing unit or maybe a separate component. The communication port may be created in software or maybe a physical connection in hardware. The communication port may be configured to connect with the communication network, external media, the display unit 573, or any other components in the user device 100-2, or combinations thereof. The connection with the communication network may be a physical connection, such as a wired Ethernet connection, or may be established wirelessly as discussed above. Likewise, the additional connections with other components of the user device 100-2 may be physical or may be established wirelessly.

The first ML model 577 and the second ML model 579 may be implemented with an AI module that may include a plurality of neural network layers. Examples of neural networks include but are not limited to, convolutional neural network (CNN), deep neural network (DNN), recurrent neural network (RNN), and Restricted Boltzmann Machine (RBM). The learning technique is a method for training a predetermined target device (for example, the user device 100-2) using a plurality of learning data to cause, allow, or control the user device 100-2 to make a determination or prediction. Examples of learning techniques include but are not limited to supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with AI may be performed through the non-volatile memory, the volatile memory, and the processor.

The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

In an example, the module(s) and/or the unit(s) and/or model(s) may include a program, a subroutine, a portion of a program, a software component, or a hardware component capable of performing a stated task or function. As used herein, the module(s) and/or the unit(s) and/or model(s) may be implemented on a hardware component such as a server independently of other modules, or a module can exist with other modules on the same server, or within the same program. The module(s) and/or unit(s) and/or model(s) may be implemented on a hardware component such as processor one or more microprocessors, microcomputers, microcontrollers, digital signal processors, central processing units, state machines, logic circuitries, and/or any devices that manipulate signals based on operational instructions. The module(s) and/or unit(s) and/or model(s), when executed by the processor(s), may be configured to perform any of the described functionalities.

A GPS (Global Positioning System) sensor 581 may be used to determine the location information of the user. The GPS sensor may be a compact user device 100-2 that receives and processes signals from GPS satellites to determine the precise position of the user device 100-2 in real time.

A battery charge level sensor 583 measures and monitors the remaining charge or energy level of a battery 571 of the user device 100-2. The battery charge level sensor 583 may determine the available capacity of the battery 571 and may estimate the remaining runtime of the user device 100-2. Battery charge level sensors 583 may utilize various techniques such as voltage measurement, current sensing, impedance analysis, or coulomb counting to accurately assess the battery's energy level. The information of the energy level of the battery 571 may also be used in managing and optimizing battery usage.

Some example embodiments disclosed herein may be implemented using processing circuitry. For example, some example embodiments disclosed herein may be implemented using at least one software program running on at least one hardware device and performing network management functions to control the elements.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown, nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The proposed method advantageously downloads the content in advance, taking into account the user device's network connectivity in the past. This approach ensures a seamless experience for the user, even when they are predicted to be offline in the future. By pre-downloading the content, the user can access and interact with the content without any interruptions or reliance on an internet connection. This method enhances user experience by providing continuous access to the desired content, regardless of network availability.

The proposed method advantageously uses a personalized approach to content delivery. By considering the past network connectivity and content consumption of a particular user, the method predicts the volume of content that will be consumed by that user. This personalized approach ensures that only the necessary volume of content is downloaded to the user's device. As a result, this method avoids excessive downloading, which can lead to increased data costs, higher battery consumption, and increased local storage usage. By optimizing the volume of the content based on user preferences and usage patterns, the method provides a more efficient and cost-effective content delivery experience.

The proposed method advantageously considers the state of the battery while predicting the volume of content to be downloaded. The method may cancel the download when the device's battery is low. This ensures that the user's device can be used for any necessary calls or tasks without disruption. By considering the state of the battery and deferring certain requests, the method aims to optimize the user's experience of using their device while preserving battery life.

The proposed method advantageously utilizes a context monitoring module to incorporate additional information, such as location, into the prediction process. By considering context information like whether the user is at home, in an office, at a hotel, or in a coffee shop, the method can make more accurate predictions and improve overall performance. This contextual awareness from the context information allows for richer predictions, enabling the system to adapt user behavior based on the user's specific situation.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for downloading a volume of content to a user device, for displaying on a lock screen of the user device, for consumption of the content by a user, the method comprising:
detecting, by a network connectivity monitoring module, one or more network connectivity events based on monitoring a network connectivity of the user device;
generating, by a network connectivity logger, a first timestamp log including one or more timestamps of the detected one or more network connectivity events;
determining, by a content consumption monitoring module, a consumption of the content by the user when the content is displayed on the lock screen of the user device including when the user device does not have network 11 connectivity;
generating, by a content consumption logger, a second timestamp log including one or more timestamps associated with each of the determined consumption of the content by the user;
predicting, by a network connectivity prediction engine configured for using a first Machine Learning model, a next time interval, within a predefined time duration, during which the user device is unlikely to have the network connectivity, based on the first timestamp log;
predicting, by a content consumption prediction engine configured for using a second Machine Learning model, a first volume of content likely to be consumed by the user in the predefined time duration, based on the second timestamp log;
determining, by a decision engine based on the predicted first volume of content, a second volume of content likely to be consumed by the user in the predicted next time interval; and
sending, by the decision engine, a request to a content server for downloading the determined second volume of content at a time before the 28 predicted next time interval.

2. The method as claimed in claim 1, wherein monitoring the network connectivity includes monitoring a status of the network connectivity and monitoring a type of network, and the status of the network connectivity is one of online or offline, and the type of the network is one of a cellular network or Wi-Fi network.

3. The method as claimed in claim 1, wherein the determining of the consumption of content includes determining a time at which the content is consumed by the user, a duration of content consumption by the user, and a third volume of content consumed by the user in the determined duration.

4. The method as claimed in claim 3, wherein
the determining of the consumption of content is based on monitoring of one or more user actions on the lock screen at a time when the content is being displayed on the lock screen, and
the one or more actions include a click operation, a swipe operation, or a scroll operation of the user on the lock screen.

5. The method as claimed in claim 1, comprising:
monitoring, by a battery monitoring module, a battery charge level of the user device and one or more connection events for charging the battery of the user device; and
generating, by a battery charge level logger, a third timestamp log including one or more timestamps associated with the one or more connection events for charging the battery and the battery charge level over a predetermined time period, wherein the determining the second volume of content is based on the third timestamp log.

6. The method as claimed in claim 5, comprising:
determining, by the decision engine, whether information associated with a battery level, in the third timestamp log, indicates that a battery charge level is below a threshold level; and
restricting, by the decision engine, a transmission of the request to the content server upon the determination that information associated with the battery charge level indicates that the battery charge level is below the threshold level.

7. The method as claimed in claim 5, comprising:
determining, by the decision engine, whether the third timestamp log indicates that the user device is in a charging state; and
sending, by the decision engine, upon the determination that the user device is in the charging state, a request to the content server for downloading an additional volume of content in addition to the determined second volume of content.

8. The method as claimed in claim 1, comprising:
determining, by a context monitoring module, one or more context data associated with the user at a time of the one or more network connectivity events;
generating, by a context logger, a fourth timestamp log including one or more timestamps of the one or more context data associated with the user;
predicting, by the network connectivity prediction engine using the first Machine Learning model, the next time interval during which the user device is unlikely to have the network connectivity, based on the first timestamp log and the fourth timestamp log;
predicting, by the content consumption prediction engine using the second Machine Learning model, the first volume of content likely to be consumed by the user in the predefined time duration, based on the second timestamp log and the fourth timestamp log; and
sending, by the decision engine, the request to the content server for downloading the second volume of content.

9. The method as claimed in claim 1, wherein the first volume of content includes a second volume of content and a third volume of content likely to be consumed by the user in a time interval of the predefined time duration during which the user device is likely to have the network connectivity.

10. The method as claimed in claim 1, wherein the second volume of content is determined to be equal to the first volume of content if the user device is unlikely to have the network connectivity in the complete predefined time duration.

11. A system for downloading a volume of content to a user device, for display on a lock screen of the user device for consumption of a content by a user, the system comprising:
a network connectivity monitoring module configured to detect one or more network connectivity events based on monitoring of a network connectivity of the user device;
a network connectivity logger configured to generate a first timestamp log including one or more timestamps of the detected one or more network 8 connectivity events;
a content consumption monitoring module configured to determine a consumption of the content by the user when the content is displayed on the lock screen of the user device including when the user device does not have network connectivity;
a content consumption logger configured to generate a second timestamp log including one or more timestamps associated with each of the determined consumption of the content by the user;
a network connectivity prediction engine configured to predict, using a first Machine Learning model, a next time interval, within a predefined time duration, during which the user device is unlikely to have the network connectivity, based on the first timestamp log;
a content consumption prediction engine configured to predict, using a second Machine Learning model, a first volume of content likely to be consumed by the user in the predefined time duration, based on the second timestamp log; and
a content consumption logger configured to generate a second timestamp log including one or more timestamps associated with each of the determined consumption of the content by the user;
a network connectivity prediction engine configured to predict, using a first Machine Learning model, a next time interval, within a predefined time duration, during which the user device is unlikely to have the network connectivity, based on the first timestamp log;
a content consumption prediction engine configured to predict, using a second Machine Learning model, a first volume of content likely to be consumed by the user in the predefined time duration, based on the second timestamp log; and
a decision engine configured to:
determine, based on the predicted first volume of content, a second volume of content likely to be consumed by the user in the predicted next time interval; and
send a request to a content server for downloading the determined second volume of content at a time before the predicted next time interval.

12. The system as claimed in claim 11, wherein
monitoring the network connectivity includes monitoring a status of the network connectivity and monitoring a type of network, and
the status of the network connectivity is one of online or offline, and the type of the network is one of a cellular network or Wi-Fi network.

13. The system as claimed in claim 11, wherein the determination of the consumption of content includes determine a time at which the content is consumed by the user, a duration of content consumption by the user, and a third volume of content consumed by the user in the determined duration.

14. The system as claimed in claim 13, wherein:
the content consumption monitoring module is configured to determine the consumption of content based on monitoring of one or more user actions on the lock screen at a time when the content is being displayed on the lock screen, and
the one or more actions include a click operation, a swipe operation, or a scroll operation of the user on the lock screen.

15. The system as claimed in claim 11, comprising:
a battery monitoring module configured to monitor a battery charge level of the user device and one or more connection events for charging the battery of the user device; and
a battery charge level logger configured to generate a third timestamp log including one or more timestamps associated with the one or more connection events for charging the battery and the battery charge level over a predetermined time period, wherein the determination of the second volume of content is based on the third timestamp log.

16. The system as claimed in claim 15, wherein the decision engine is configured to:
determine whether information associated with a battery level, in the third timestamp log, indicates that a battery charge level is below a threshold level; and
restrict a transmission of the request to the content server upon the determination that information associated with the battery charge level indicates that the battery charge level is below the threshold level.

17. The system as claimed in claim 15, wherein the decision engine is configured to:
determine whether the third timestamp log indicates that the user device is in a charging state; and
send, upon the determination that the user device is in the charging state, a request to the content server for downloading an additional volume of content in addition to the determined second volume of content.

18. The system as claimed in claim 11, comprising:
a context monitoring module configured to determine one or more context data associated with the user at a time of the one or more network connectivity events; and
a context logger configured to generate a fourth timestamp log including one or more timestamps of the one or more context data associated with the user, wherein:
the network connectivity prediction engine is configured to predict, using the first Machine Learning model, the next time interval during which the user device is unlikely to have the network connectivity, based on the first timestamp log and the fourth timestamp log;
the content consumption prediction engine is configured to predict, using the second Machine Learning model, the first volume of content likely to be consumed by the user in the predefined time duration, based on the second timestamp log and the fourth timestamp log; and
the decision engine is configured to send the request to the content server for downloading the second volume of content.

19. The method as claimed in claim 1, comprising:
determining, by a context monitoring module, one or more context data associated with the user at a time of the one or more network connectivity events;
generating, by a context logger, a fourth timestamp log including
one or more timestamps of the one or more context data associated with the user;
predicting, by the network connectivity prediction engine using the first Machine Learning model, the next time interval during which the user device is unlikely to have the network connectivity, based on the first timestamp log and the fourth timestamp log;
predicting, by the content consumption prediction engine using the second Machine Learning model, the first volume of content likely to be consumed by the user in the predefined time duration, based on the second timestamp log and the fourth timestamp log; and
sending, by the decision engine, the request to the content server for downloading the second volume of content.

20. The method as claimed in claim 5, comprising:
determining, by a context monitoring module, one or more context data associated with the user at a time of the one or more network connectivity events;
generating, by a context logger, a fourth timestamp log including
one or more timestamps of the one or more context data associated with the user;
predicting, by the network connectivity prediction engine using the first Machine Learning model, the next time interval during which the user device is unlikely to have the network connectivity, based on the first timestamp log and the fourth timestamp log;
predicting, by the content consumption prediction engine using the second Machine Learning model, the first volume of content likely to be consumed by the user in the predefined time duration, based on the second timestamp log and the fourth timestamp log; and
sending, by the decision engine, the request to the content server for downloading the second volume of content.

21. The system as claimed in claim 11, comprising:
a context monitoring module configured to determine one or more context data associated with the user at a time of the one or more network connectivity events; and
a context logger configured to generate a fourth timestamp log including one or more timestamps of the one or more context data associated with the user, wherein:
the network connectivity prediction engine is configured to predict, using the first Machine Learning model, the next time interval during which the user device is unlikely to have the network connectivity, based on the first timestamp log and the fourth timestamp log;
the content consumption prediction engine is configured to predict, using the second Machine Learning model, the first volume of content likely to be consumed by the user in the predefined time duration, based on the second timestamp log and the fourth timestamp log; and
the decision engine is configured to send the request to the content server for downloading the second volume of content.

22. The system as claimed in claim 15, comprising:
a context monitoring module configured to determine one or more context data associated with the user at a time of the one or more network connectivity events; and
a context logger configured to generate a fourth timestamp log including one or more timestamps of the one or more context data associated with the user, wherein;
the network connectivity prediction engine is configured to predict, using the first Machine Learning model, the next time interval during which the user device is unlikely to have the network connectivity, based on the first timestamp log and the fourth timestamp log;
the content consumption prediction engine is configured to predict, using the second Machine Learning model, the first volume of content likely to be consumed by the user in the predefined time duration, based on the second timestamp log and the fourth timestamp log; and
the decision engine is configured to send the request to the content server for downloading the second volume of content.
